(19) United States
(12) Patent Application Publication
(10) Pub. No.: US 2013/0200694 A1
(43) Pub. Date: Aug. 8, 2013

(54) Battery comprising an Integrated Pulse Width Modulation Inverter

(71) Applicants: Stefan Butzmann, Beilstein (DE); Holger Fink, Stuttgart (DE)

(72) Inventors: Stefan Butzmann, Beilstein (DE); Holger Fink, Stuttgart (DE)

(73) Assignees: SB LiMotive Germany GmbH, Stuttgart (DE); SB LiMotive Company Ltd., Yongin-si, Gyeonggi-do (KR)

(21) Appl. No.: 13/641,456

(22) PCT Filed: Feb. 18, 2011
(86) PCT No.: PCT/EP11/52410

§ 371 Date: Feb. 25, 2013

(30) Foreign Application Priority Data
Apr. 16, 2010 (DE) 102010027856.4

(51) Int. Cl. H02M 7/44

(52) U.S. Cl. CPC H02M 7/44
USPC 307/10.1; 363/123

(57) ABSTRACT

A battery includes at least one battery cell line having a plurality of battery cells mounted in series between a respective positive battery pole and a respective negative battery pole. The battery further includes a pulse width modulation inverter integrated into the battery, at least one first and one second input, and at least one output. The first and second inputs are connected to the positive battery pole or the negative battery pole.

The present invention relates to a battery comprising an integrated pulse-controlled inverter and to an electric motor vehicle comprising a battery of this kind.

### PRIOR ART

It has become apparent that, in the future, battery systems will be increasingly used, both in stationary applications and in vehicles such as hybrid and electric vehicles. In order to be able to meet the requirements in respect of voltage and available power given for a respective application, a large number of battery cells will be connected in series. Since the current provided by a battery of this kind has to flow through all the battery cells and a battery cell can conduct only a limited current, additional battery cells are often connected in parallel in order to increase the maximum current. This can be done either by providing a plurality of cell windings within a battery cell housing or by externally interconnecting battery cells. However, one problem in this case is that compensation currents between the battery cells which are connected in parallel may occur on account of cell capacitances and voltages which are not exactly identical.

FIG. 1 illustrates the basic circuit diagram of a conventional electric drive system as is used, for example, in electric and hybrid vehicles or else in stationary applications, such as for rotor blade adjustment of wind power installations. A battery 10 is connected to a DC voltage intermediate circuit which is buffered by a capacitor 11. A pulse-controlled inverter 12 is connected to the DC voltage intermediate circuit and provides sinusoidal voltages, which are phase-offset with respect to one another, for operating an electric drive motor 13 at three outputs by means of in each case two switchable semiconductor valves and two diodes. The capacitance of the capacitor 11 has to be large enough to stabilize the voltage in the DC voltage intermediate circuit for a period of time in which one of the switchable semiconductor valves is connected. In a practical application such as an electric vehicle, the result is a high capacitance in the mF range. Owing to the usually very high voltage of the DC voltage intermediate circuit, a capacitance as high as this can be realized only with high costs and a high space requirement.

FIG. 2 shows the battery 10 of FIG. 1 in a detailed block diagram. A large number of battery cells are connected in series and optionally additionally in parallel in order to achieve a high output voltage and battery capacitance which is desired for a respective application. A charging and disconnection device 16 is connected between the positive pole of the battery cells and a positive battery terminal 14. A disconnection device 17 can optionally additionally be connected between the negative pole of the battery cells and a negative battery terminal 15. The disconnection and charging device 16 and the disconnection device 17 each comprise a contactor 18 and, respectively, 19 which are provided for disconnecting the battery cells from the battery terminals in order to switch the battery terminals such that they are at zero potential. Otherwise, there is a considerable potential for servicing personnel or the like being injured on account of the high DC voltage of the series-connected battery cells. A charging contactor 20 with a charging resistor 21 which is connected in series to the charging contactor 20 is additionally provided in the charging and disconnection device 16. The charging resistor 21 limits a charging current for the capacitor 11 when the battery is connected to the DC voltage intermediate circuit. To this end, the contactor 18 is initially left open and only the charging contactor 20 is closed. If the voltage across the positive battery terminal 14 reaches the voltage of the battery cells, the contactor 19 can be closed and the charging contactor 20 may be opened. The contactors 18, 19 and the charging contactor 20 increase the costs of a battery 10 to a considerable extent since stringent requirements are made of them in respect of reliability and the currents to be carried by them.

### DISCLOSURE OF THE INVENTION

Therefore, the invention introduces a battery comprising at least one battery cell line which has a plurality of battery cells which are connected in series between a respective positive battery pole and a respective negative battery pole. According to the invention, the battery comprises a pulse-controlled inverter which is integrated in the battery and has at least a first and a second input and also at least one output. In this case, the first and the second input of the pulse-controlled inverter are connected to the positive battery pole and, respectively, to the negative battery pole.

The invention therefore opposes a trend of integrating the pulse-controlled inverter in the electric drive motor and therefore of allowing the drive motor to appear from the outside to be a DC motor which can be connected directly to a buffer capacitor and a battery.

Integrating the pulse-controlled inverter in the battery has the advantage that the contactors provided in the prior art can be dispensed with because the high DC voltage of the battery cell line is no longer accessible from outside the battery. Instead of opening the contactors according to the prior art, the output of the pulse-controlled inverter can simply be connected to a high impedance, as a result of which the output of the pulse-controlled inverter and therefore all the outputs of the battery can be switched to zero potential without additional components. Since the battery cell line is permanently connected to the pulse-controlled inverter, any buffer capacitor which may be present will, in principle, have the voltage of the battery cell line, and therefore the charging contactor can be dispensed with too. If a buffer capacitor of this kind is provided, it preferably has a first capacitor terminal, which is connected to the positive battery pole, and a second capacitor terminal, which is connected to the negative battery pole, and is likewise integrated in the battery.

The pulse-controlled inverter can have n outputs, where n is natural number greater than 1. In this case, the pulse-controlled inverter is designed to generate and output a sinusoidal voltage at each of the outputs, said sinusoidal voltage being phase-shifted with respect to the respectively other outputs. The number n is preferably 3, in order to provide a suitable interface to the rotating-field motors which are usual in the prior art.

The battery can have n battery cell lines, with the pulse-controlled inverter having n pairs of inputs, in each case one pair of said pairs of inputs being connected to the positive or negative battery pole of an associated one of the n battery cell lines. Instead of a single battery cell line and DC voltage intermediate circuit, the number of DC voltage intermediate circuits equals the number of outputs of the pulse-controlled inverter provided. This provides the advantage that buffer capacitors can have smaller dimensions or be dispensed with completely. In addition, the capacitance of the battery is divided between a plurality of independent battery cell lines, as a result of which compensation currents no longer occur between the battery cells or battery cell lines which are otherwise connected in parallel.

The pulse-controlled inverter can contain n first semiconductor valves and n second semiconductor valves, with in each case one of the n first semiconductor valves being connected between an associated first input of a pair of inputs and a respective one of the n outputs, and in each case one of the n second semiconductor valves being connected between the respective one of the n outputs and an associated second input of the pair of inputs.

The battery can also have 2*n diodes, in each case one of said diodes being connected back-to-back in parallel to one of the n first or n second semiconductor valves.

Pulse-controlled inverters of this kind can be controlled, for example, in a known manner by pulse-width modulation.

The battery can have a cooling apparatus which is designed to cool both the battery cells and the pulse-controlled inverter. Since the pulse-controlled inverter is integrated in the battery, the additional expenditure for cooling in each case the pulse-controlled inverter and battery cells is dispensed with. In this case, the pulse-controlled inverter can advantageously be cooled in series after the battery cells are cooled since the pulse-controlled inverter can reach higher temperatures than the battery cells and therefore, after flowing through the battery cell lines, the coolant is still cool enough to cool the pulse-controlled inverter too.

It is likewise possible to reduce the total expenditure by the controllers for the battery (cell balancing, charging and discharging, state of charge determination) and the pulse-controlled inverter (driving the semiconductor valves) being combined.

The battery cells are particularly preferably lithium-ion battery cells. Lithium-ion battery cells have the advantages of a high cell voltage and a particularly high capacitance by volume.

A second aspect of the invention relates to a motor vehicle comprising an electric drive motor for driving the motor vehicle and comprising a battery, which is connected to the electric drive motor, according to the first aspect of the invention.

### DRAWINGS

Exemplary embodiments of the invention will be explained in greater detail with reference to the drawings and the following description. In the drawings:

FIG. 1 shows an electric drive system according to the prior art,

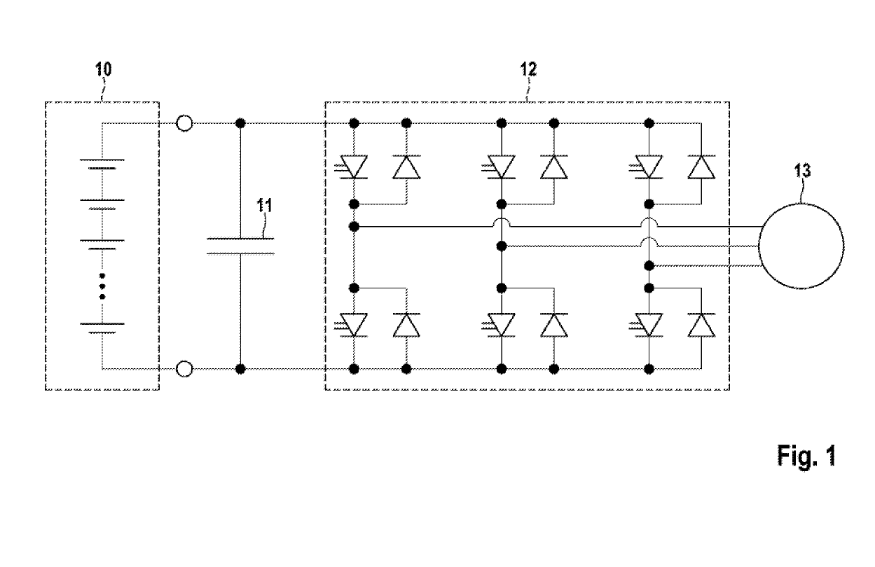

FIG. 2 shows a block circuit diagram of a battery according to the prior art,

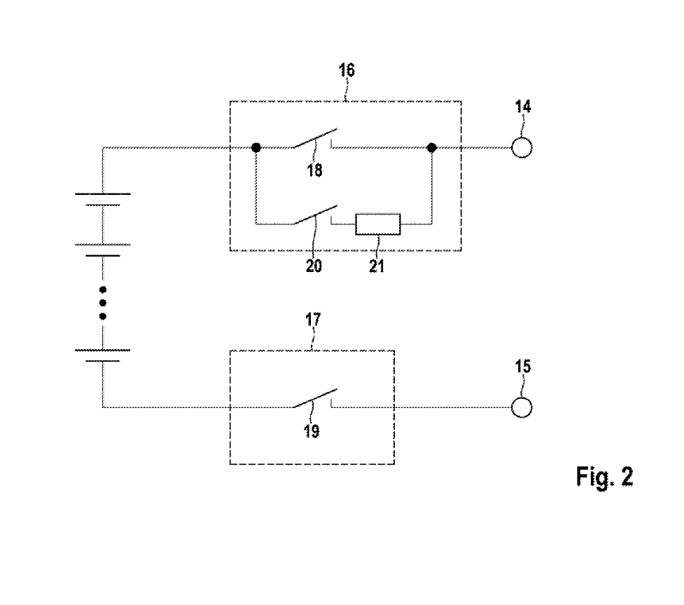

FIG. 3 shows a first exemplary embodiment according to the invention, and

FIG. 4 shows a second exemplary embodiment of the invention.

### EMBODIMENTS OF THE INVENTION

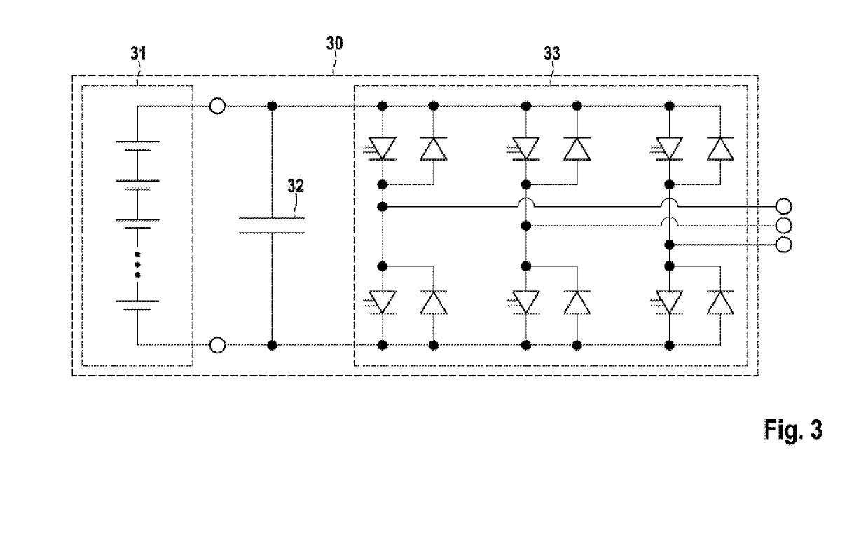

FIG. 3 shows a first exemplary embodiment of the invention. A battery line 31, a buffer capacitor 32 and a pulse-controlled inverter 33 are integrated in the battery 30, with any contactors for disconnecting the positive and negative pole of the battery line being dispensed with. The pulse-controlled inverter 33 is advantageously designed to connect all its outputs to high impedance when, for example, the battery 30 is intended to be replaced and therefore is intended to be disconnected from a drive motor or the like which is connected to the pulse-controlled inverter 33. In this way, the battery 30 is completely at zero potential with respect to the outside, and therefore there is no potential for injury.

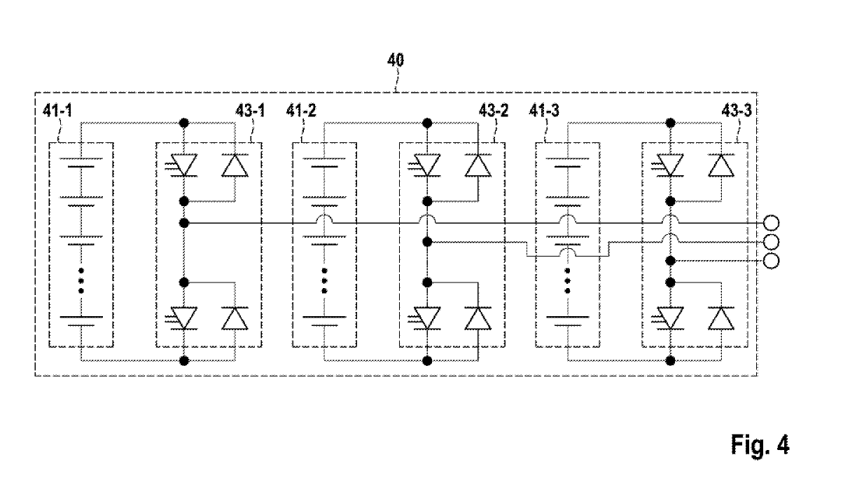

FIG. 4 a second exemplary embodiment of the invention. The battery 40 has a plurality of battery lines, in the shown example three battery lines 41-1, 41-2, 41-3. However, the battery 40 could also have two or more than three battery lines. However, the number of three battery lines is advantageous because it allows simple connection of the battery 40 to standardized electric motors with three phase connections. The pulse-controlled inverter 43 is likewise broken down into as many parts 43-1, 43-2, 43-3 as there are battery lines 41-1, 41-2, 41-3. In this case, in each case one of the parts 43-1, 43-2, 43-3 is connected to a battery line 41-1, 41-2, 41-3. On account of the very much lower loading of each battery line 41-1, 41-2, 41-3 by a part 43-1, 43-2, 43-3 of the pulse-controlled inverter 43, a buffer capacitor can be dispensed with in the shown exemplary embodiment. In the shown example, each part 43-1, 43-2, 43-3 of the pulse-controlled inverter 43 contains two semiconductor valves and two diodes which are connected back-to-back in parallel to the semiconductor valves. The semiconductor valves are preferably controlled by a control unit by pulse-width modulation. However, any desired forms of pulse-controlled inverters can be used in principle.

1. A battery comprising:
at least one battery cell line having a plurality of battery cells which are connected in series between a respective positive battery pole and a respective negative battery pole; and
a pulse-controlled inverter which is integrated in the battery and includes (i) at least a first input and a second input and (ii) at least one output,
wherein the first input and the second input are connected to the positive battery pole and, respectively, to the negative battery pole.

2. The battery as claimed in claim 1, further comprising:
a buffer capacitor which has a first capacitor terminal, which is connected to the positive battery pole, and a second capacitor terminal, which is connected to the negative battery pole, and which is integrated in the battery.

3. The battery as claimed in claim 1, wherein:
the pulse-controlled inverter has n outputs, where n is a natural number greater than 1,
the pulse-controlled inverter is configured to generate and output a sinusoidal voltage at each of the outputs, and
said sinusoidal voltage is phase-shifted with respect to the respectively other outputs.

4. The battery as claimed in claim 3, wherein:
the battery includes n battery cell lines,
the pulse-controlled inverter has n pairs of inputs, and
in each case one pair of said pairs of inputs is connected to the positive or negative battery pole of an associated one of the n battery cell lines.

5. The battery as claimed in claim 4, wherein:
the pulse-controlled inverter contains n first semiconductor valves and n second semiconductor valves,
in each case one of the n first semiconductor valves is connected between an associated first input of a pair of inputs and a respective one of the n outputs, and
in each case one of the n second semiconductor valves is connected between the respective one of the n outputs and an associated second input of the pair of inputs.

6. The battery as claimed in claim 5, further comprising:
2*n diodes,
wherein in each case one of said diodes is connected back-to-back in parallel to one of the n first or n second semiconductor valves.

7. The battery as claimed in claim 6, wherein n is equal to 3.

8. The battery as claimed in claim 1, further comprising:
a cooling apparatus which is configured to cool both the battery cells and the pulse-controlled inverter.

9. The battery as claimed in claim 1, wherein the battery cells are lithium-ion battery cells.

10. A motor vehicle comprising:
an electric drive motor configured to drive the motor vehicle; and
a battery, which is connected to the electric drive motor, and includes (i) at least one battery cell line having a plurality of battery cells which are connected in series between a respective positive battery pole and a respective negative battery pole, and (ii) a pulse-controlled inverter which is integrated in the battery and has at least a first input and a second input and at least one output,
wherein the first input and the second input are connected to the positive battery pole and, respectively, to the negative battery pole.
